(19) United States
(12) Patent Application Publication
(10) Pub. No.: US 2011/0184559 A1
(43) Pub. Date: Jul. 28, 2011

(54) SYSTEM AND METHOD FOR CONTROLLING A MACHINE BY CORTICAL SIGNALS

(75) Inventor: Alim-Louis Benabid, Meylan (FR)

(73) Assignee: COMM. A L'ENERGIE ATOMIQUE ET AUX ENERGIES ALT., Paris (FR)

(21) Appl. No.: 12/994,998

(22) PCT Filed: May 28, 2009
(86) PCT No.: PCT/FR2009/000623

§ 371 Date: Apr. 14, 2011

(30) Foreign Application Priority Data
May 29, 2008 (FR) 0802958

(51) Int. Cl. G05B 19/00

(52) U.S. Cl. 700/264; 901/2

(57) ABSTRACT

A system for controlling a machine by cortical signals, including: a mechanism acquiring electrophysiological signals originating from a plurality of locations in the cerebral cortex of a human or animal subject; a producing device adapted to input the electrophysical signals and output control signals from the machine in response to predetermined variations in the characteristics of the electrophysiological signals. At least some of the electrophysiological signals are from predetermined cortex regions and not associated with any performed or imagined activity nor with any sensory stimuli visualized by the human or animal subject. A method for controlling a machine by cortical signals can use such a system.

The invention relates to a system and to a method for controlling a machine by cortical signals.

Direct neuronal interfaces enabling an external device to be controlled by detecting electrophysiological signals from the cerebral cortex of an animal or human subject have been studied since the 1970s. At present, it is possible to train patients or laboratory animals to control simple devices “by thought”, e.g. to move a cursor on a screen. In 2006, a tetraplegic patient was able, via a direct neuronal interface, to use a computer and a TV set, to open and close a hand prosthesis, and even to perform simple movements with a robot arm. On this topic, reference may be made to the article by Leigh R. Hochberg et al. “Neuronal ensemble control of prosthetic devices by a human with tetraplegia”, Nature 442, 164-171 (Jul. 13, 2006).

In the relatively near future, such neuroelectronic systems should be capable of significantly improving the quality of life of paralyzed people, by giving them some degree of autonomy. In a more remote future, they might also be used for increasing the capabilities of healthy subjects (“hands-free” control of various devices, etc.).

At present, the best results in this field have been obtained using systems of the invasive type, where electrophysiological signals are acquired by electrodes that penetrate inside the cerebral cortex (see the above-mentioned article by Leigh R. Hochberg et al.). Non-invasive systems, making use of electroencephalographic signals taken through a subject's scalp have also been proposed. Such systems are nevertheless more difficult to use, and they require intense training of the subject; in addition, their performance is not very satisfactory, in particular because of the poor spatial resolution of electroencephalographic electrodes. The use of electrocorticographic electrodes implanted inside the skull but not penetrating the cortex appears to constitute a promising middle way.

Direct neuronal interfaces using electrocorticographic signals are described in particular in the following articles:
E. A. Felton, J. A. Wilson, J. C. Williams, and P. C. Garell “Electrocorticographically controlled brain-computer interfaces using motor and sensory imagery in patients with temporary subdural electrode implants. Report of four cases”, J. Neurosurg. 106 (2006), 495-500; and
G. Schalk, J. Kubanet, K. J. Miller, N. R. Anderson, E. C. Leuthardt, J. G. Ojemann, D. Limbrick, D. W. Moran, L. A. Gerhardt, and J. R. Wolpaw “Decoding two-dimensional movement trajectories using electrocorticographic signals in humans”, J. Neural. Eng. 4 (2007), 264-275.

Those two articles describe experiments performed on patients suffering from epilepsy and having electrocorticographic electrodes implanted temporarily for medical reasons.

In both articles, the electrocorticographic signals were acquired and analyzed while the patients were performing movements of the arms, the tongue, the eyes, etc., or were merely imagining such movements, or indeed were evoking images or sounds to which they had previously been exposed. Spectral characteristics of the signals from certain zones of the brain were identified as being suitable for use in controlling a device (the movement of a cursor on a screen). Thereafter, the subjects are trained to actually control the device “by thinking” making use of the characteristics of the electrophysiological signals that were identified during the analysis stage. In other words, the patients learnt to modulate the spectral amplitudes of the signals from certain areas of their cortexes by performing or imagining they were performing simple actions, or indeed by evoking certain sensory stimuli.

Thus, for example, one subject was trained to control the vertical and horizontal movements of a cursor by imagining moving the tongue and the right hand respectively. The horizontal control signals for the cursor were generated on the basis of variations in the amplitude of the electrophysiological signal from Brodmann's area No. 43 of the left cerebral hemisphere in the 90 hertz (Hz)-95 Hz and the 110 Hz-115 Hz bands. To generate the horizontal control signal, a linear combination of signals from a plurality of Brodmann's areas and from a plurality of frequency bands was used (signal from area No. 2 in the 90 Hz-95 Hz band; signal from area No. 3 in the 85 Hz-90 Hz band; signal from area No. 6 in the 115 Hz-120 Hz and 125 Hz-130 Hz bands).

One of the main difficulties encountered for implementing that method lies in the fact that each action, whether performed or imagined, or each sensory stimulus, whether actually perceived or merely evoked, activates a plurality of cortical areas simultaneously, and gives rise to variations in the electrophysiological signals from those areas in a plurality of frequency bands. In order to actuate N degrees of freedom of a machine reliably, it is therefore necessary to identify at least as many cortical signal characteristics coming from various areas of the cortex, and in which the induced variations are substantially not mutually correlated. In practice, it is very difficult to identify more than two or three characteristics or combinations of characteristics that satisfy this condition.

That is why the possibility of controlling more than two or three degrees of freedom by means of electrocorticographical signals has yet to be reported.

The use of intracortical electrodes enables a greater number of degrees of freedom to be controlled, but at the cost of being very much more invasive.

In any event, this is still a long way from the 10 to 20 degrees of freedom that a tetraplegic patient would need in order to achieve genuine autonomy by controlling a system of effectors such as a complex robot or an exoskeleton enabling the patient to perform body movements.

The invention proposes overcoming this limitation by generating control signals by making use of characteristic variations of electrophysiological signals coming from areas of the cortex that are determined a priori, without being associated with actions that are performed or imagined, and without being associated with sensory stimuli evoked by said animal or human subject.

The idea on which the invention is based consists in making use of the plasticity of the cerebral cortex, which is capable of directly modulating electrocorticographical signals. This is a radical change of approach. In the prior art, the modulations in the electrocorticographical signals were produced indirectly, constituting a kind of collateral effect of a mental act having no direct relationship with controlling a machine. In contrast, in accordance with the invention, the subject's brain can learn to activate in voluntary manner various areas of its own cortex so as to generate signals that are directly oriented to controlling a machine.

This new approach is advantageous since it enables better use to be made of the potential of the cerebral cortex. A larger number of decorrelated characteristics can thus be identified, thereby making it possible to control simultaneously a greater number of degrees of freedom.

In a first embodiment of the invention, only the association between the control signals and the areas of the cortex is arbitrary, whereas the variations in the characteristics of the signal (amplitude, frequency band) that are best suited for controlling the actuator are identified during a “training” stage. The term “training” should be understood here in the sense that it is the system that is “trained” to identify the signals that are issued voluntarily by the various areas of the subject's cortex.

In a second embodiment of the invention, the “target” characteristics of the electrocorticographical signals are likewise determined a priori, and they are associated arbitrarily with control signals. This embodiment allows an even greater number of degrees of freedom to be controlled, but the subject needs to put a more intense effort into training. Here it is not the system that is “trained” to recognize the signals generated by the individual: it is the individual who needs to learn how to generate the expected signals in voluntary manner, using the cortical areas specified for this purpose. It can be understood that this second embodiment is significantly more difficult to implement.

The system and the method of the invention are particularly suitable for controlling effectors such as servomotors, robots or exoskeletons, particularly when a plurality of degrees of freedom are to be actuated in independent manner. Nevertheless, the invention also makes it possible to control machines for processing information, such as computers, e.g. to run and control the execution of programs.

The invention thus provides a system for controlling a machine by cortical signals, the system comprising: means for acquiring electrophysiological signals from a plurality of locations of the cortex of the brain of an animal or human subject; and computing means adapted to receive said electrophysiological signals as input and to output control signals for said machine in response to predetermined variations in the characteristics of said electrophysiological signals; the system being characterized in that at least some of said electrophysiological signals come from areas of the cortex that are determined a priori, without being associated with actions that are performed or imagined, and without being associated with sensory stimuli that are evoked by said animal or human subject.

In particular embodiments of the invention:
Said computing means are adapted to make use of signals coming from areas that are distributed in approximately uniform manner over a portion of the surface of said cortex (having surface areas of a few square centimeters to several tens or even hundreds of square centimeters).
Said computing means are adapted to generate said control signals from variations in characteristics of said electrophysiological signals that are determined a priori.
Said machine is selected from: a robot; an exoskeleton; a computer running one or more applications.
Said means for acquiring electrophysiological signals are selected from: a network of implantable electrocorticographic electrodes; and a network of electroencephalographic electrodes suitable for being placed on the subject's scalp.

The invention also provides a method of controlling a machine by cortical signals, the method comprising the steps consisting in: acquiring a plurality of electrophysiological signals from different locations of the cortex of the brain of an animal or human subject; detecting predetermined variations of certain characteristics of said electrophysiological signals; and in response to said variations, generating control signals for controlling said machine; the method being characterized in that at least some of said predetermined variations in characteristics of the electrophysiological signals come from areas of the cortex that are determined a priori without being associated with actions that are performed or imagined, and without being associated with sensory stimuli that are evoked by said animal or human subject.

The method may also comprise a preliminary step of training said individual, the method comprising the substeps consisting in: selecting one or more locations of the cortex and temporarily associating them arbitrarily with a signal for controlling said machine; training the brain of said subject to activate said areas of the cortex voluntarily to cause variations in the characteristics of the electrophysiological signals coming therefrom in such a manner as to control said machine in desired manner; and as a function of the failure or success of said training, confirming or canceling the provisional association between variations of characteristics and control signals; said substeps being repeated, each time changing the associations between areas of the cortex and control signals until a sufficient number of said associations have been confirmed.

In a first implementation of the invention, said preliminary training step also includes a substep consisting in training the brain of said subject to give rise to characteristic variations that are determined a priori in the electrophysiological signals from said areas of the cortex; the training substeps being repeated, each time changing the associations between the characteristics of the electrophysiological signals and the control signals until a sufficient number of said associations have been confirmed.

In an alternative implementation, the method may also include a preliminary step of identifying characteristics of the electrophysiological signals from said cortical areas that are suitable for use in generating said control signals.

Advantageously, during said training step, return information representative of variations in the characteristics may be supplied to the subject. More particularly, said return information may include at least some information selected from: indirect information indicative of the control signal received by the machine; and direct information indicative of the characteristics of the electrophysiological signals used for control purposes.

Said electrophysiological signals may in particular be selected from among: electrocorticographic signals acquired via a network of implanted electrodes; and electroencephalographic signals acquired via a network of electrodes placed on the subject's scalp.

Other characteristics, details, and advantages of the invention appear on reading the description made with reference to the accompanying drawing given by way of example and in which:

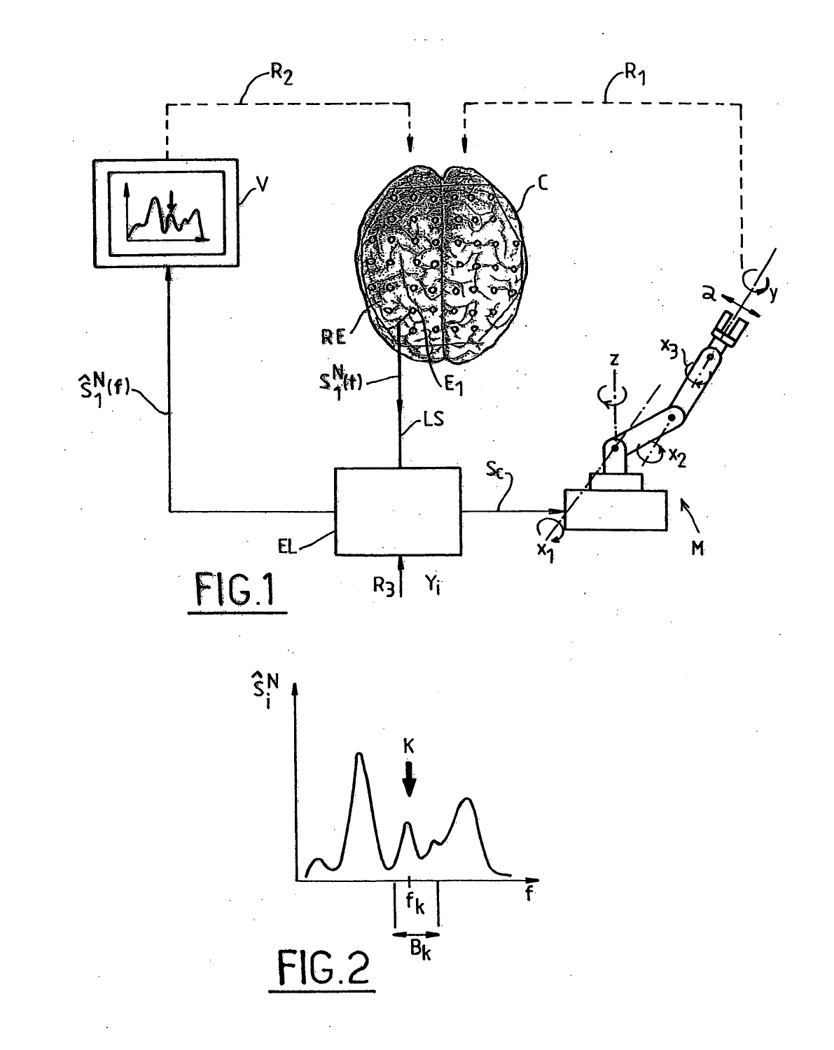

FIG. 1 is a diagram showing the principle of a control system of the invention; and

FIG. 2 shows the spectrum of a cortical signal of the kind that can be used by the system of FIG. 1.

FIG. 1 shows a human brain C having an network RE of electrocorticographic electrodes RE placed thereon, the electrodes being connected to computing means EL via a signal link LS that may be a wired link or that is preferably a wireless link.

For reasons of clarity, the figure shows only one signal link LS for conveying the signal s₁^{N}(t) from an electrode E₁ to the computing means EL. The superscript N indicates that it is a neurophysiological signal, while the subscript corresponds to the electrode from which the signal comes. In reality, all of the electrodes (or at least a large fraction of them) are connected to the computing means EL. In order to acquire a sufficiently large number of electrophysiological signals, the electrode network RE needs to cover a substantial fraction of the convex surface of the cortex of the brain C.

The computing means EL process the electrophysiological signals sᵢ^{N}(t) from the electrodes Eᵢ in order to generate control signals S_{c} for controlling a machine M. In this example, the machine is a robot arm having six degrees of freedom (rotation about axes x₁, x₂, x₃, y, and z, and varying the spacing a of the clamp acting as a hand).

The machine is controlled in a closed loop: this means that the subject using the system (and in particular the subject's brain C) receives information in return. This information may comprise in particular information indicative of control signals received by the machine: this takes place quite naturally via a sensory channel, enabling the individual to observe the movement of the machine M (possibly a tactile return and/or an auditory return may also be envisaged, particularly if the subject presents any sensory deficit). The return channel is represented in the figure by feedback loop R₁.

It is also possible to provide the subject with direct return information, indicative of the characteristics of the electrophysiological signals that are used for control purposes. To do this, the FIG. 1 system includes a screen V connected to the computing means for displaying a graph of the spectrum Ŝ₁^{N}(f) of the electrophysiological signal s₁^{N}(t). This second return channel (feedback loop R₂) is particularly useful in the training stage, as described in detail below.

FIG. 2 shows the spectrum Ŝ₁^{N}(f) of the signal s₁^{N}(t) from the electrode E₁ in greater detail. In this example, the characteristic K that is used for control purposes, and that is pointed to by an arrow, is the spectral amplitude of the signal in the band Bₖ centered about the frequency fₖ. Variations in this characteristic are associated, possibly in arbitrary manner, with actuating any one of the six degrees of freedom of the machine M. In a variant, the combined characteristics of one or more signals may be used for actuating a single degree of freedom.

As mentioned above, the electrophysiological signals sᵢ^{N}(t) are preferably acquired by means of one or more arrays of cortical electrodes. These electrodes are connected to a pretreatment device via wired connections. The pretreatment device generates a signal that can be used by a posttreatment device, the connection between said pretreatment device and the posttreatment device being a wired connection or a connection of the electromagnetic wave transmission type. The posttreatment device generates control signals for one or more effectors, the connection between the posttreatment device and the effector(s) being of the wired or wireless type (transmission via electromagnetic waves).

The electrodes may be subdural or extradural, where subdural electrodes present better resolution and greater signal amplitude, but are much more invasive.

Probes comprising flexible arrays of cortical electrodes and suitable for implementing the invention are commercially available, since they have been developed for therapeutic applications such as treating epilepsy or pain. Reference may be made by way of example to the article by C. M. Chin et al. “Identification of arm movements using correlation of electrocorticographic spectral components and kinematic recordings”, J. Neural Eng. 4 (2007), 146-158, describing the use of a Metronic 3586 probe for recording cortical signals. Each array typically comprises two to 200 electrodes, usually arranged in a grid of square or rectangular meshes, with the spacing between electrodes generally being of the order of 1 centimeter (cm). Arrays containing only a single line of electrodes may also be used.

Each electrode comprises a contact stud made using a biocompatible conductive material, e.g. iridium platinum (Pt 90-Ir 10), graphite, carbon nanotubes, a conductive metal oxide (e.g. indium tin oxide (ITO)), an alloy (e.g. MP35N), etc. The active portion has a surface area lying in the range a few hundreds of square micrometers (μm²) to 20 square millimeters (mm²) approximately. The support on which the electrodes are fastened is advantageously a flexible and insulating support, of surface area lying in the range a few square centimeters (cm²) to several hundreds of cm², and of thickness lying in the range a few hundreds of micrometers (μm) to a few millimeters (mm). Such a support may be made of flexible biocompatible material such as a benzocyclobutene (BCB) type polymer, a polyimide (e.g. Pi2611), a polyimide-isoindoro-quinazorindione (PIQ), a parylene, an elastomer of the injectable silicone type (e.g. sold under the references MED-4720 or Q7-4720 respectively by the suppliers Nusil and Dow Corning), and also a polyurethane or polyvinyl chloride.

Each electrode is connected to its own measurement channel that may be constituted by a wire made of metal, of conductive metal oxide such as ITO, or of graphite. The measurement channels may also be constituted by a plane metal track, e.g. made by depositing conductive ink on a flexible substrate, or indeed by sintering (in particular laser sintering) a nanopowder. The measurement channel is preferably integrated in the flexible material of the support.

Each measurement channel is connected to at least one electrode.

The network of electrodes may be connected to a base that is fastened to the skull of the instrumented subject, the base being designed to receive a connector for making a connection with the pretreatment device which is then situated on the outside, via a wired connection.

The array of electrodes may also be connected via a wired connection, e.g. using high density connectors, to a compact pretreatment device that is implanted either within the skull or on the skull.

Preferably, the pretreatment device performs preamplification, filtering, multiplexing, and analog-to-digital conversion on the signal. In a first embodiment, the pretreatment device may be connected to the unit on the skull or the scalp of the subject via a wired connection.

In another embodiment, the pretreatment device may be implemented in the form of one or more dedicated integrated circuits (or application specific integrated circuits (ASICs)) that may likewise be integrated in the implantable unit. Such a pretreatment device in the form of an ASIC is described in the publication by O. Billoint, J. P. Rostaing, G. Charvet, and B. Yvert: “A 64-channel ASIC for in-vitro simultaneous recording and stimulation of neurons using microelectrode arrays”, EMBS 2007, IEEE 29th Annual International Conference of the Engineering in Medicine and Biology Society, 2007.

Additional means for treating information may also be included in the pretreatment device, e.g. means suitable for performing signal processing operations such as amplification, filtering, or classification. Such processor means make it possible in particular to extract parameters that are characteristic of the measured signal. When using intracranial implantation, the device may be placed in a confinement having a shape that matches the anatomy of the subject and that is made using biocompatible material.

The pretreatment device may operate with a power source of the optionally rechargeable battery type, where recharging may be performed by a wired connection or by remote transmission; the device preferably has a system for managing its energy reserves.

The information from the pretreatment device may be transferred to a device for posttreatment of the signal, via a wired connection or by wireless transmission, e.g. using electromagnetic waves.

The signal posttreatment device is constituted by signal processor means known to the person skilled in the art, serving to amplify and analyze the signal transmitted by the pretreatment device. In particular, it may comprise means for performing the functions of amplification, filtering, parameter extraction, or correlation with other signals. The device also includes means for controlling one or more effectors, by wired or radio connection. It may be external or implanted, and if implanted it includes a power supply of the optionally rechargeable battery type, where recharging may be performed by wire or by remote transmission.

In another embodiment, the pretreatment and posttreatment devices are included in the same housing, which may be external or implanted. For example it may comprise an association of a plurality of dedicated ASICs.

In another embodiment, all or part of the pretreatment and posttreatment devices may be external during an initial stage, e.g. for establishing characteristic parameters of the signal, so as to enable a plurality of effectors to be controlled in satisfactory manner. All or some of these devices may also be external during a training stage, during which the subject learns how to control the effectors. At the end of this stage, these devices, or some of them, may be implanted.

In the simplified diagram of FIG. 1, the pretreatment device and the posttreatment device are represented together as the computing means EL.

The signal from the pretreatment module is received by the treatment device in order to be amplified, filtered by a lowpass filter or by a bandpass filter, typically having a passband covering the range 0.1 Hz to 500 Hz, and then sampled (sampling at a frequency lying in the range 500 Hz to a few kilohertz (kHz)), and digitized.

In a first embodiment of the invention, the association between areas of the cortex and signals for controlling the machine M is made a priori, in arbitrary manner, however the characteristics of the electrophysiological signals coming from said cortical areas suitable for use in generating said control signals are identified during a preliminary training step.

In the context of this preliminary step, the computing unit EL receives as input an electrophysiological signal sᵢ(t) acquired by an electrode Eᵢ, together with a signal Yᵢ(t) representative of actuating the i^{th} degree of freedom Mᵢ of the machine M (or the effector Mᵢ). In the simplest circumstances, this signal Yᵢ is a variable that is a function of the intention of the individual to effect a sensing or motor action, preferably being actuating an effector Mᵢ. For example, this variable may be boolean, taking the value 1 when the subject imagines actuating the i^{th} degree of freedom of the machine and value 0 otherwise (input R3).

The following step consists in establishing an indicator expressing the dependency of one or more characteristics of the neurophysiological signal as measured in this way relative to the variable Yᵢ indicating the intention to perform a motor or sensory action, e.g. actuating the effector Mᵢ. The characteristic may be selected among amplitude or power in one or more frequency bands. This dependency may be determined by methods known to the person skilled in the art, as described in the literature, e.g. in the above-mentioned publications by E. Felton et al. and G. Schalk et al., and also in G. Schalk et al. “Two-dimensional movement control using electrocorticographic signals in humans”, J. of Neural Engineering 5 (2008), 75-84.

For example, if the characteristic of the signal sᵢ being used is power in one or more frequency bands, the electrophysiological signal sᵢ(t) may be converted in the frequency domain Ŝᵢ(f) by a non-parametric method, such as the Fourier transform or by parametric techniques, e.g. autoregression. The signal expressed in the frequency domain may be resolved into P spectral bands each having a width equal to 5 Hz, for example: Ŝᵢ(fⱼ) with j=1 to P.

The indicator expressing the dependency of this or these characteristics relative to the variable Yᵢ may for example be determined by a correlation coefficient r between the signal Yᵢ and the power of the signal Ŝᵢ(f) in each spectral band. By way of example, this coefficient may be calculated using the following formula:

$${r}_{j}^{i} = \frac{〈 [ {S}_{i} ( {f}_{j} ) - {μ}_{S} ( {f}_{j} ) ] \cdot [ {Y}_{i} - {μ}_{Y}^{i} ] 〉}{{σ}_{S} ( {f}_{j} ) \cdot {σ}_{Y}^{i}}$$

where:
< . . . > indicates the time averaging operation;
μₛ(fⱼ) and σₛ(fⱼ) are respectively the mean and the standard deviation of Ŝᵢ^{N}(fⱼ); and
μ_{Y}ⁱ and σ_{Y}ⁱ are respectively the mean and the standard deviation of the signal Yᵢ.

The correlation rⱼⁱ indicates the dependency between the electrophysiological signal sᵢ(t) in its j^{th} spectral band, and the intention of the individual to actuate the i^{th} degree of freedom of the machine M. In practice, since rⱼⁱ may take values that might equally well be positive or negative, consideration is preferably given to its square (rⱼⁱ)².

The Q (where Q<P) spectral bands of the signal sᵢ(t) having the squared correlation coefficient (rⱼⁱ)² that is the greatest, or that exceeds a certain threshold, are considered as being suitable for controlling the i^{th} degree of freedom of the machine. Generally, Q lies in the range 1 to 5.

Thereafter, the output signal Sⁱ_{c} for controlling the i^{th} degree of freedom of the machine is determined as a function of the characteristics Ŝᵢ(f_{q}) presenting the correlation levels that are the most meaningful, using methods known to the person skilled in the art and described in the above-mentioned publications, and also in the following documents:
D. J. McFarland and J. R. Wolpaw “Sensorimotor rhythm-based brain computer interface (BCI): feature selection by regression improves performance”, IEEE Transactions on Neural Systems and Rehabilitation Engineering, Vol. 13, September 2005, 372-379; and
P. Shenoy et al. “Generalized features for electrocorticographic BCIs”, IEEE Transactions on Biomedical Engineering, Vol. 55, No. 1, January 2008, 273-280.

For example, Sⁱ_{c} may be the result of a weighted sum of some of the characteristics of the measured electrophysiological signal:

$${S}_{c}^{i} = {\sum }_{q = 1}^{Q} {a}_{q} \cdot {\hat{S}}_{i} ( {f}_{q} )$$

where a_{q} are parameters that are to be determined, e.g. by linear regression.

Classification algorithms may also be used, making it possible to determine a set of characteristics Ŝᵢ(f_{g}) that, in combination, generate the control for the effector i. See for example the above-mentioned articles by C. M. Chin and P. Shenoy.

After this preliminary step, during which the system learns to decode the signals generated by the subject's cortex, it is necessary to provide a second training step during which the subject learns to make use of the system to control the machine M in the desired manner. In particular, the subject must practice activating determined areas of the cerebral cortex in order to generate determined signals in voluntary manner while minimizing interfering signals that might control the machine M in uncontrolled manner.

These operations are repeated, each time changing the associations between the characteristics of the electrophysiological signals and the control signals until a sufficient number of said associations has been confirmed, thus making it possible to control a corresponding number of degrees of freedom of the machine M (generally at least 2 or 3, preferably 5 or more, or indeed 10 or more).

In a second embodiment of the invention, the preliminary step of identifying control signals may be omitted. In this embodiment of the invention, the characteristics (amplitudes or powers in one or more frequency bands), and the cortical areas are associated arbitrarily with controlling particular degrees of freedom of the machine. It will be understood that the training stage for the subject may then be significantly longer and more difficult than with the first embodiment.

1-12. (canceled)

13. A system for controlling a machine by cortical signals, the system comprising:
means for acquiring electrophysiological signals from a plurality of locations of a cortex of a brain of an animal or human subject; and
computing means for receiving the electrophysiological signals as an input and to output control signals for the machine in response to predetermined variations in characteristics of the electrophysiological signals;
wherein at least some of the electrophysiological signals come from areas of the cortex that are determined a priori, without being associated with actions that are performed or imagined, and without being associated with sensory stimuli that are evoked by the animal or human subject.

14. A system according to claim 13, wherein the computing means is adapted to make use of signals coming from areas that are distributed in approximately uniform manner over a portion of a surface of the cortex.

15. A system according to claim 13, wherein the computing means is adapted to generate the control signals from variations in characteristics of the electrophysiological signals that are determined a priori.

16. A system according to claim 13, wherein the machine is selected from: a robot; an exoskeleton; a computer running one or more applications.

17. A system according to claim 13, wherein the means for acquiring electrophysiological signals are selected from:
a network of implantable electrocorticographic electrodes; and
a network of electroencephalographic electrodes configured to be placed on the subject's scalp.

18. A method of controlling a machine by cortical signals, the method comprising:
acquiring a plurality of electrophysiological signals from different locations of a cortex of a brain of an animal or human subject;
detecting predetermined variations of certain characteristics of the electrophysiological signals; and
in response to the variations, generating control signals for controlling the machine;
wherein at least some of the predetermined variations in characteristics of the electrophysiological signals come from areas of the cortex that are determined a priori without being associated with actions performed or imagined, nor with sensory stimuli evoked by the animal or human subject.

19. A method according to claim 18, further comprising preliminary training the individual, including:
selecting one or more locations of the cortex and temporarily associating them arbitrarily with a signal for controlling the machine;
training the brain of the subject to activate the areas of the cortex voluntarily to cause variations in the characteristics of the electrophysiological signals coming therefrom so as to control the machine in a desired manner; and
as a function of failure or success of the training, confirming or canceling provisional association between variations of characteristics and control signals;
repeating the above operations each time changing associations between areas of the cortex and control signals until a sufficient number of the associations have been confirmed.

20. A method according to claim 19, wherein the preliminary training further comprises training the brain of the subject to give rise to characteristic variations that are determined a priori in the electrophysiological signals from the areas of the cortex; the training being repeated, each time changing the associations between the characteristics of the electrophysiological signals and the control signals until a sufficient number of the associations have been confirmed.

21. A method according to claim 19, further comprising including preliminary identifying characteristics of the electrophysiological signals from the cortical areas that are suitable for use in generating the control signals.

22. A method according to claim 19, wherein during the training, return information representative of variations in the characteristics is supplied to the subject.

23. A method according to claim 22, wherein the return information includes at least some information selected from:
indirect information indicative of the control signal received by the machine; and
direct information indicative of the characteristics of the electrophysiological signals used for control purposes.

24. A method according to claim 18, wherein the electrophysiological signals are selected from among:
electrocorticographic signals acquired via a network of implanted electrodes; and
electroencephalographic signals acquired via a network of electrodes placed on the subject's scalp.
